(19) United States
(12) Patent Application Publication
(10) Pub. No.: US 2025/0271571 A1
(43) Pub. Date: Aug. 28, 2025

(54) TIME-RESOLVED DISTANCE AND ANGLE DETERMINATION USING RADIO AND RADAR SIGNALS

(71) Applicant: Infineon Technologies AG, Neubiberg (DE)

(72) Inventors: Bernhard Wedl, Graz (AT); Reinhold Schmidt, Graz (AT)

(21) Appl. No.: 19/059,638

(22) Filed: Feb. 21, 2025

(30) Foreign Application Priority Data
Feb. 23, 2024 (DE) 102024105182.5

(51) Int. Cl. G01S 13/87; B60R 25/24; B60R 25/30; G01S 13/02; G01S 13/42; G01S 13/76; G07C 9/27

(52) U.S. Cl. CPC G01S 13/87; B60R 25/30; G01S 13/42; G01S 13/76; G07C 9/27; B60R 25/245; G01S 13/0209

(57) ABSTRACT

A device including a first radio device, which is designed to exchange radio signals with a second radio device which is spaced apart from the first radio device, for the time-resolved determination of a first distance and/or an angle of incidence between the first radio device and the second radio device; a radar device which is designed to detect objects in an environment of the device and for the time-resolved determination of a second distance to the second radio device and/or an angle between the device and the second radio device; and a processor which is designed to determine whether the determined first distance is temporally correlated with the second distance and/or whether the angle of incidence is temporally correlated with the angle between the device and the second radio device.

### TECHNICAL FIELD

The disclosure relates to a device, a system and a method for operating a device.

### BACKGROUND

Radio signals can be used in certain applications to determine the distance between a radio device and a second radio device.

For example, in Ultra Wide Band (UWB) applications, a standardized method is used to determine the distance between radio devices (also known as ranging, or distance determination based on time of flight (ToF)) and for their relative positioning, for example their relative 2D or 3D angular position. The 2D angular position is also referred to as the “2D Angle of Arrival (2D-AOA)” or 2D angle of incidence, and the 3D angular position is referred to as the “3D Angle of Arrival (3D-AOA) ”, or 3D angle of incidence.

In some cases, UWB radio signals are used to implement access control using distance values determined by UWB.

For example, a lock or a locking mechanism can be switched using the determined distance values.

Unauthorized accesses are attempted, and at least so-called “relay attacks” and “physical layer attacks” are sometimes known to succeed.

In the case of a relay attack, a signal from a radio key can be forwarded from an intermediate “relay station” to a receiver (e.g. a vehicle) and possibly amplified and/or modified.

In a physical layer attack, for example, an attacker can provide additional pulses that reach the receiver earlier than the actual pulses, which can lead to a reduction in the determined distance.

### SUMMARY

In various exemplary aspects, either the same (or similar) radio devices, which are used for an (e.g. standardized, e.g. by means of UWB) distance determination between the radio device and a second radio device, can be used additionally for determining a distance to an object by means of radar.

In the standardized UWB distance determination (ranging), radio signals are actively transmitted from each of the participating radio devices: The first radio device sends a request for distance determination to the second radio device, which then sends a response pulse.

In contrast, in the case of a radar-based use of the radio device (also referred to as UWB-sensing), only this device sends a radio signal and detects reflections of the radio signal at surrounding objects, in order to determine their distance (and, optionally, relative position).

For such a use, in various exemplary aspects the radio device (for example, by using both types of use alternately) and/or an additional radio radar device can be used.

Alternatively, a microwave radar device, which is part of the device, can be used for the distance measurement by radar.

An investigation into whether there is a temporal correlation between the distances between a first and a second radio device determined by means of UWB-ToF measurements and those determined by means of radar measurements, can be used to determine whether the second radio device (or its owner) is located near the first radio device.

In other words, the data obtained by UWB-ToF measurements and those obtained by the radar measurements can be checked for consistency in order to detect an attack and refuse to provide a function, for example if the distance is below a predefined distance.

One advantage of this approach, for example, is that no hardware change is necessary to allow such use with existing radio equipment. Instead, a software update is sufficient.

Even for the use of a microwave radar device for the radar measurement, it is possible to omit hardware changes in some cases (e.g. in vehicles that are already equipped with radar devices for detecting distances to objects), but according to various exemplary aspects the device can be realised, optionally, by means of a software update.

In various exemplary aspects, a device is provided. The device comprises a first radio device, which is designed for exchanging radio signals with a second radio device which is spaced apart from the first radio device, for the time-resolved determination of a first distance and/or an angle of incidence between the first radio device and the second radio device; a radar device which is designed for detecting objects in an environment of the device and for the time-resolved determination of a second distance to the second radio device and/or an angle between the device and the second radio device; and a processor which is designed to determine whether the determined first distance is temporally correlated with the second distance and/or whether the angle of incidence is temporally correlated with the angle between the device and the second radio device.

The radar device may be realised in various exemplary aspects by means of the first radio device, which is operated intermittently in the form of a radar device. In this case, the first radio device may be designed to emit radio signals (e.g. radio pulses), receive reflections thereof at surrounding objects (e.g. persons or objects), to analyse the reflections and from them derive distances and, optionally, angles to the objects.

In various exemplary aspects, the radar device may be a radar device different from the first radio device, for example, a radar device operating in the microwave range.

In the device, a measurement of a ToF distance to a user can be carried out by means of its radio device.

In addition, the radar device can be used to determine a distance to objects in the environment of the device and to check whether one of the determined distances matches that which was determined by means of the ToF measurement.

### DESCRIPTION OF THE DRAWINGS

Exemplary aspects of the disclosure are illustrated in the figures and are explained in more detail below.

In the figures:

FIG. 1A shows a schematic illustration of the use of a device according to various exemplary aspects during legitimate use;

FIG. 1B shows a schematic illustration of the use of a device according to various exemplary aspects during an unauthorised attack;

FIG. 1C shows a schematic illustration of the values that are used to detect whether the two measured distances are correlated, for the case of the illustration of 1A;

FIG. 1D shows a schematic illustration of the values that are used to detect whether the two measured distances are correlated, for the case of the illustration of 1B;

FIG. 2A shows a schematic illustration of a device and a system according to various exemplary aspects;

FIG. 2B shows a schematic illustration of a device and a system according to various exemplary aspects; and

FIG. 3 shows a flowchart of a method for operating a device according to various exemplary aspects.

### DETAILED DESCRIPTION

In the detailed description that follows, reference is made to the accompanying drawings, which form part of said description and show, for illustration, specific aspects in which the aspects of the disclosure may be performed. In this regard, direction terminology such as, for instance, “at the top”, “at the bottom”, “at the front”, “at the back”, “front”, “rear”, etc. is used with respect to the orientation of the figure(s) described. Since components of aspects may be positioned in a number of different orientations, the directional terminology is used for illustration and is not restrictive in any way. It goes without saying that other aspects may be used and structural or logical changes may be made, without departing from the scope of protection of the aspects of the present disclosure. It goes without saying that the features of the various exemplary aspects described herein may be combined with one another, unless specifically stated otherwise. The detailed description that follows should therefore not be interpreted in a restrictive sense, and the scope of protection of the aspects of the present disclosure is defined by the attached claims.

Within the scope of this description, the terms “connected” and “coupled” are used to describe both a direct and an indirect connection and direct or indirect coupling. In the figures, identical or similar elements are provided with identical reference signs if expedient.

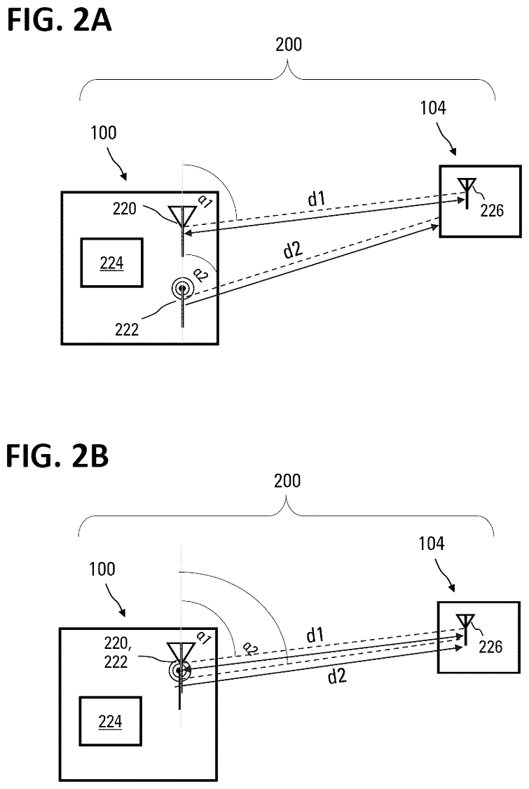

FIG. 2A and FIG. 2B each show a schematic representation of a device 100 and a system 200 according to different exemplary aspects.

FIG. 2A shows a device 100 which has a first radio device 220.

The device 100 may, for example, be a vehicle which when approached by the vehicle user is able to be unlocked by means of a radio key which the user carries with him, or other electronic devices, for example, a computer (such as a laptop) that allows access to the computer when a person carrying an electronic token approaches, or similar applications.

The first radio device 220 may also be designed for exchanging radio signals with a second radio device 104 (e.g., the key or the token), which is spaced apart from the first radio device 220.

For example, the first radio device 220 may have a radio antenna, for example, a UWB radio antenna.

The first radio device 220 may be designed, for example, to emit or receive an (e.g. standardized) request for carrying out a distance determination (ranging).

The first radio device 220 may also be arranged for the time-resolved determination of a first distance d1 and/or an angle of incidence α1 between the first radio device 220 and the second radio device 104.

The determination of the first distance d1 (and/or, optionally, the angle of incidence α1) can be performed in the first radio device 220, or, for example, in a processor 224, which can be part of the device 100, wherein the processor can be coupled with the first radio device 220.

The device 100 may further comprise a radar device 222, which may be designed for detecting objects (e.g. the user 102) in an environment of the device 100 and for the time-resolved determination of a second distance d2 to the second radio device 104 and/or an angle α2 between the device 100 and the second radio device 104.

FIG. 2A illustrates an exemplary aspect of a device 100, in which the first radio device 220 and the radar device 222 are separate devices.

The first radio device 220 may be, for example, a UWB radio device which is configured to transmit and receive UWB radio signals in a range between approximately 6.5 GHz and approximately 10 GHz.

The radar device 222 may also be, for example, a radio device that transmits and receives in the UWB range, in any case according to a radar principle (emitting the pulse and receiving the reflections, as explained above), or a radar device 222 which transmits in the microwave range that is typical for radar devices.

FIG. 2B illustrates an exemplary aspect of a device 100, in which the first radio device 220 and the radar device 222 are implemented by the same device. This can be made possible, for example, by operating the first radio device 220 alternately as an (e.g.) UWB ranging device and as a UWB radar device.

The processor 224 may be designed to determine whether the determined first distance d1 is temporally correlated with the second distance d2 and/or whether the angle of incidence α1 is temporally correlated with the angle α2 between the device 100 and the second radio device 104.

“Time-resolved distance measurement” (or time-resolved angle measurement) means that the distance (and/or angle) measurement is performed as a series of temporally consecutive individual measurements. The time intervals used can be regular or irregular and can be in the range of fractions of a second, e.g. in the range of microseconds.

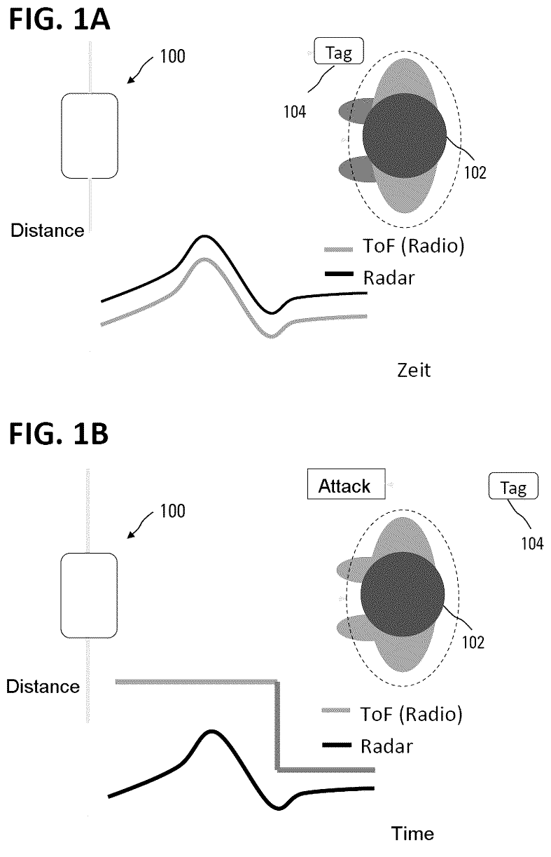

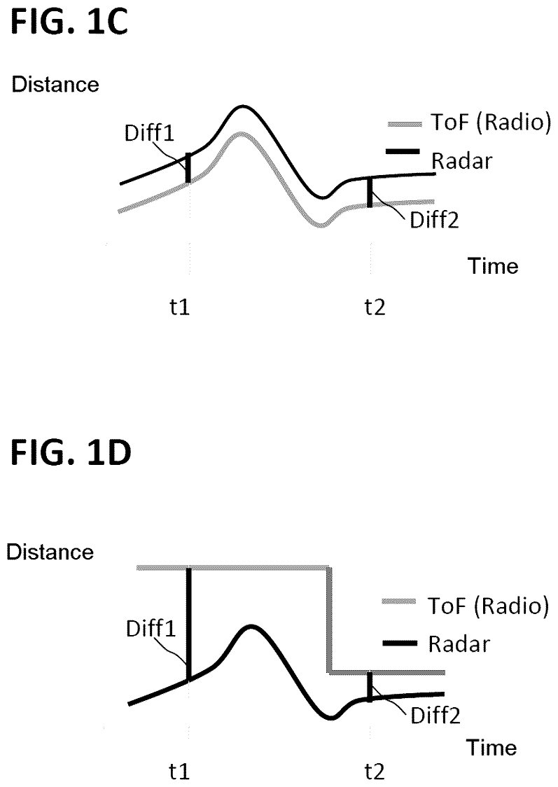

FIG. 1C shows a schematic illustration of values that are used to detect whether the two measured distances are correlated, for the case of the illustration of 1A, and FIG. 1D shows a schematic illustration for the case of the illustration of 1B.

FIGS. 1C and 1D illustrate the time-resolved measurement, in each case only illustrated using two exemplary times, t1 and t2.

For the purposes of this description, “at a time” means that measurements taken at the same time (in FIG. 1C and 1D, for example at times t1 or t2), do not need to be taken exactly at the same time, but only optionally actually completely simultaneously, and otherwise within a tolerance limit. This takes account of the fact that, at least in the case of the exemplary aspect illustrated in FIG. 2B, because of the dual use of the radio device 220 also as the second device 222, the distance measurements will occur a short distance after one another (for example, at an interval of a few nanometres or a few micrometers).

As already indicated above, the device 100 may be designed to perform, enable or cause a predetermined action (for example, to permit entry or access), if the determination results in the distance d1 determined by means of the radio device 220 being temporally correlated with the distance to the object d2 and/or the angle of incidence α1 being temporally correlated with the angle α2 between the device and the object 104.

Conversely, the device may be designed to prevent a predetermined action if the determination results in the distance d1 determined by means of the radio device 220 being different to the distance d2 to the object 104 and/or the angle of incidence α1 being different to the angle α2 between the device 100 and the object 104.

The time-resolved determination of the first distance d1 and/or the angle of incidence α1 may comprise a determination at a first time t1 and at a second time t2, wherein the first time and the second time are temporally separated by at least 1 second.

A time interval of this order of magnitude, which is large compared to the time interval at which the individual measurements are made (within the one second—and also outside of it—a large number of distance measurements tN are typically performed), can be used to record single or random matches. The distance or angle measurement can also be carried out at any other time point tN.

This is illustrated by the comparison of FIG. 1C with FIG. 1D: In FIG. 1C, the curves illustrating the two distance measurements, namely the one carried out by means of ToF and the one carried out by radar, run synchronously for the entire time (and thus also during the times t1 and t2), as shown by, among other things, the fact that their difference (shown at times t1 and t2) is constant.

In contrast, the curves in FIG. 1D are only close to each other for a short period of time (although not synchronous).

A single measurement at time t2 could lead to the assumption that a valid access request is being made. However, the joint evaluation with the measurement at time t1 leads to the conclusion that the differences between the distance measurements d1 and d2 at time t1 and t2 differ greatly, that this is an attack and the action that is to be affected thereby must be prevented.

In other words, the first distance determined is temporally correlated with the second distance if a difference between the second distance and the first distance at time t1 is substantially equal to the difference between the second distance and the first distance at time t2.

Substantially equal can mean in this case that the two differences do not differ by more than about 10% of their mean value.

The same applies to the alternative or additional use of the angles: The angle of incidence is temporally correlated with the angle between the device and the object if a difference between the angle between the device and the object and the angle of incidence at time t1 is substantially equal to the difference between the angle of incidence and the angle between the device and the object at time t2.

The device 200 also comprises, in addition to the device 100, the second radio device 104.

The second radio device 104 may be designed, for example, as an electronic key or as a smartphone.

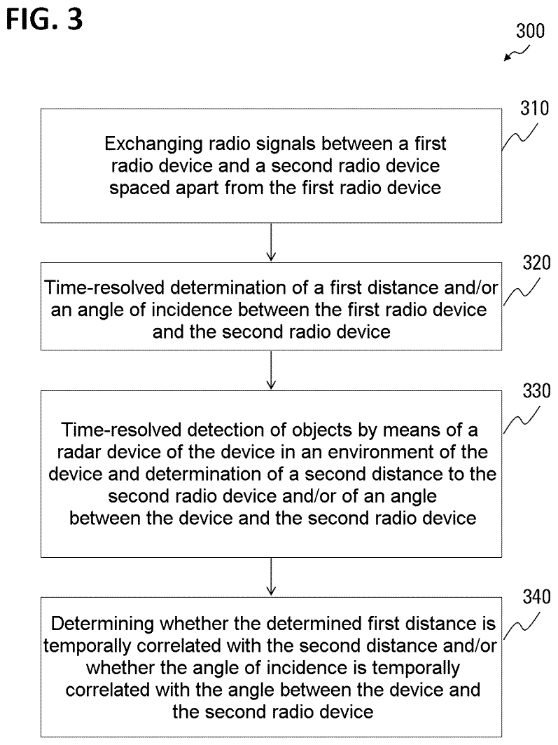

FIG. 3 shows a flowchart 300 of a method for operating a device comprising a first radio device and a radar device, according to various exemplary aspects.

The method comprises exchanging radio signals between the first radio device and a second radio device spaced apart from the first radio device (310), time-resolved determination of a first distance and/or an angle of incidence between the first radio device and the second radio device (320), a time-resolved detection of objects by means of the radar device in an environment of the device and determination of a second distance to the second radio device and/or of an angle between the device and the second radio device (330), and determining whether the determined first distance is temporally correlated with the second distance and/or whether the angle of incidence is temporally correlated with the angle between the device and the second radio device (340).

Some exemplary aspects are specified in summary below.

Exemplary aspect 1 is a device comprising a first radio device which is designed for exchanging radio signals with a second radio device which is spaced apart from the first radio device, for the time-resolved determination of a first distance and/or an angle of incidence between the first radio device and the second radio device; a radar device which is designed for detecting objects in an environment of the device and for the time-resolved determination of a second distance to the second radio device and/or an angle between the device and the second radio device; and a processor which is designed to determine whether the determined first distance is temporally correlated with the second distance and/or whether the angle of incidence is temporally correlated with the angle between the device and the second radio device.

Exemplary aspect 2 is a device according to exemplary aspect 1, designed to perform, enable or cause a predetermined action if the determination results in the distance determined by means of the radio device being temporally correlated with the distance to the object and/or the angle of incidence being temporally correlated with the angle between the device and the object.

Exemplary aspect 4 is a device according to exemplary aspect 1 or 2, designed to prevent a predetermined action if the determination results in the distance determined by means of the radio device being different to the distance to the object and/or the angle of incidence being different to the angle between the device and the object.

Exemplary aspect 4 is a device according to exemplary aspect 2 or 3, wherein the predetermined action comprises granting entry or access.

Exemplary aspect 5 is a device according to any of the exemplary aspects 1 to 4, wherein the time-resolved determination of the first distance and/or the angle of incidence comprises a determination at a first time t1 and at a second time t2, wherein the first time and the second time are temporally separated by at least 1 second.

Exemplary aspect 6 is a device according to exemplary aspect 5, wherein the time-resolved determination of the second distance and/or the angle between the device and the object comprises a determination at the first time t1 and at the second time t2.

Exemplary aspect 7 is a device according to exemplary aspect 5 or 6, designed to perform the time-resolved determination of the first distance and/or the angle of incidence and of the second distance and/or the angle between the device and the object at at least one additional time tN.

Exemplary aspect 8 is a device according to exemplary aspect 6 or 7, wherein the determined first distance is temporally correlated with the second distance if a difference between the second distance and the first distance at time t1 is substantially equal to the difference between the second distance and the first distance at time t2.

Exemplary aspect 9 is a device according to any of the exemplary aspects 6 to 8, wherein the angle of incidence is temporally correlated with the angle between the device and the object if a difference between the angle between the device and the object and the angle of incidence at time t1 is substantially equal to the difference between the angle of incidence and the angle between the device and the object at time t2.

Exemplary aspect 10 is a device according to any of the exemplary aspects 1 to 9, wherein the radar device is the first radio device operated in radar mode or an additional radio device.

Exemplary aspect 11 is a device according to any of the exemplary aspects 1 to 9, wherein the radar device is designed to detect objects by means of microwaves.

Exemplary aspect 12 is a device according to any of the exemplary aspects 1 to 11, wherein the radio signals are UWB signals or comprise UWB signals.

Exemplary aspect 13 is a device according to any of the exemplary aspects 1 to 12, designed as a vehicle, access door or computer device.

Exemplary aspect 14 is a system comprising a device according to any of the exemplary aspects 1 to 13 and the second radio device.

Exemplary aspect 15 is a system according to exemplary aspect 14, wherein the second radio device is designed as an electronic key or as a smartphone.

Exemplary aspect 16 is a method for operating a device which comprises a first radio device and a radar device. The method comprises exchanging radio signals between the first radio device and a second radio device spaced apart from the first radio device, time-resolved determination of a first distance and/or an angle of incidence between the first radio device and the second radio device, a time-resolved detection of objects by means of the radar device in an environment of the device and determination of a second distance to the second radio device and/or of an angle between the device and the second radio device, and determining whether the determined first distance is temporally correlated with the second distance and/or whether the angle of incidence is temporally correlated with the angle between the device and the second radio device.

Exemplary aspect 17 is a method according to exemplary aspect 16, which further comprises performing, enabling or causing a predetermined action if the determination results in the distance determined by means of the radio device being temporally correlated with the distance to the object and/or the angle of incidence being temporally correlated with the angle between the device and the object.

Exemplary aspect 18 is a method according to exemplary aspect 16 or 17, which is also designed to prevent a predetermined action if the determination results in the distance determined by means of the radio device being different to the distance to the object and/or the angle of incidence being different to the angle between the device and the object.

Exemplary aspect 19 is a method according to exemplary aspect 17 or 18, wherein the predetermined action comprises granting entry or access.

Exemplary aspect 20 is a method according to any of the exemplary aspects 16 to 19, wherein the time-resolved determination of the first distance and/or the angle of incidence comprises a determination at a first time t1 and at a second time t2, wherein the first time and the second time are temporally separated by at least 1 second.

Exemplary aspect 21 is a method according to exemplary aspect 20, wherein the time-resolved determination of the second distance and/or the angle between the device and the object comprises a determination at the first time t1 and at the second time t2.

Exemplary aspect 22 is a method according to exemplary aspect 20 or 21, which is also designed to perform a time-resolved determination of the first distance and/or the angle of incidence and of the second distance and/or the angle between the device and the object at at least one additional time tN.

Exemplary aspect 23 is a method according to exemplary aspect 21 or 22, wherein the determined first distance is temporally correlated with the second distance if a difference between the second distance and the first distance at time t1 is substantially equal to the difference between the second distance and the first distance at time t2.

Exemplary aspect 24 is a method according to any of the exemplary aspects 21 to 23, wherein the angle of incidence is temporally correlated with the angle between the device and the object if a difference between the angle between the device and the object and the angle of incidence at time t1 is substantially equal to the difference between the angle of incidence and the angle between the device and the object at time t2.

Exemplary aspect 25 is a method according to any of the exemplary aspects 16 to 24, wherein the radar device is the first radio device operated in radar mode or an additional radio device.

Exemplary aspect 26 is a device according to any of the exemplary aspects 16 to 24, wherein the radar device is designed to detect objects by means of microwaves.

Exemplary aspect 27 is a method according to any of the exemplary aspects 16 to 26, wherein the radio signals are UWB signals or comprise UWB signals.

Exemplary aspect 28 is a method according to any of the exemplary aspects 16 to 27, wherein the device is configured as a vehicle, access door or computer device.

Further advantageous configurations of the system are evident from the description of the method, and vice versa.

1. A device, comprising:
a first radio device which is designed to exchange radio signals with a second radio device which is spaced apart from the first radio device, for a time-resolved determination of a first distance and/or an angle of incidence between the first radio device and the second radio device;
a radar device which is designed to detect objects in an environment of the device and for a time-resolved determination of a second distance to the second radio device and/or an angle between the device and the second radio device; and
a processor which is designed to determine whether the determined first distance is temporally correlated with the second distance and/or whether the angle of incidence is temporally correlated with the angle between the device and the second radio device.

2. The device as claimed in claim 1, designed to perform, enable, or cause a predetermined action if the determination results in the distance determined using the radio device being temporally correlated with the distance to the object and/or the angle of incidence being temporally correlated with the angle between the device and the object.

3. The device as claimed in claim 1, designed to prevent a predetermined action if the determination results in the distance determined using the radio device being different to the distance to the object and/or the angle of incidence being different to the angle between the device and the object.

4. The device as claimed in claim 2, wherein the predetermined action comprises granting entry or access.

5. The device as claimed in claim 1, wherein the time-resolved determination of the first distance and/or the angle of incidence comprises a determination at a first time t1 and at a second time t2, wherein the first time and the second time are temporally separated by at least 1 second.

6. The device as claimed in claim 5, wherein the time-resolved determination of the second distance and/or the angle between the device and the object comprises a determination at the first time t1 and at the second time t2.

7. The device as claimed in claim 5, designed to perform the time-resolved determination of the first distance and/or the angle of incidence and of the second distance and/or the angle between the device and the object at at least one additional time tN.

8. The device as claimed in claim 6, wherein the first distance determined is temporally correlated with the second distance if a difference between the second distance and the first distance at time t1 is substantially equal to the difference between the second distance and the first distance at time t2.

9. The device as claimed in claim 6, wherein the angle of incidence is temporally correlated with the angle between the device and the object if a difference between the angle between the device and the object and the angle of incidence at time t1 is substantially equal to the difference between the angle of incidence and the angle between the device and the object at time t2.

10. The device as claimed in claim 1, wherein the radar device is the first radio device operated in radar mode or an additional radio device.

11. The device as claimed in claim 1, wherein the radar device is designed to detect objects using microwaves.

12. The device as claimed in claim 1, wherein the radio signals are UWB signals or comprise UWB signals.

13. The device as claimed in claim 1, designed as a vehicle, access door, or computer device.

14. A system, comprising:
a device as claimed in claim 1; and
the second radio device.

15. The system as claimed in claim 14, wherein the second radio device is designed as an electronic key or as a smartphone.

16. A method for operating a device comprising a first radio device and a radar device, the method comprising:
exchanging radio signals between the first radio device and a second radio device spaced apart from the first radio device;
time-resolved determining a first distance and/or angle of incidence between the first radio device and the second radio device;
time-resolved detecting objects using the radar device in an environment of the device and determining a second distance to the second radio device and/or of an angle between the device and the second radio device; and
determining whether the determined first distance is temporally correlated with the second distance and/or whether the angle of incidence is temporally correlated with the angle between the device and the second radio device.

17. The method as claimed in claim 16, further comprising:
performing, enabling, or causing a predetermined action if the determination results in the distance determined using the radio device being temporally correlated with the distance to the object and/or the angle of incidence being temporally correlated with the angle between the device and the object.

18. The method as claimed in claim 16, further comprising:
preventing a predetermined action if the determination results in the distance determined using the radio device being different to the distance to the object and/or the angle of incidence being different to the angle between the device and the object.

19. The method as claimed in claim 17, wherein the predetermined action comprises granting entry or access.

20. The method as claimed in claim 16, wherein the time-resolved determining the first distance and/or the angle of incidence comprises determining at a first time t1 and at a second time t2, wherein the first time and the second time are temporally separated by at least 1 second.

21. The method as claimed in claim 20, wherein the time-resolved determining the second distance and/or the angle between the device and the object comprises determining at the first time t1 and at the second time t2.

22. The method as claimed in claim 20, further comprising:
time-resolved determining the first distance and/or the angle of incidence and of the second distance and/or the angle between the device and the object at at least one additional time tN.

23. The method as claimed in claim 21, wherein the first distance determined is temporally correlated with the second distance if a difference between the second distance and the first distance at time t1 is substantially equal to the difference between the second distance and the first distance at time t2.

24. The method as claimed in claim 21, wherein the angle of incidence is temporally correlated with the angle between the device and the object if a difference between the angle between the device and the object and the angle of incidence at time t1 is substantially equal to the difference between the angle of incidence and the angle between the device and the object at time t2.

25. The device as claimed in claim 16, wherein the radar device is the first radio device operated in radar mode or an additional radio device.

26. The device as claimed in claim 16, wherein the radar device is designed to detect objects using microwaves.

27. The method as claimed in claim 16, wherein the radio signals are UWB signals or comprise UWB signals.

28. The method as claimed in claim 16, wherein the device is designed as a vehicle, access door, or computer device.
